(19) United States
(12) Patent Application Publication
(10) Pub. No.: US 2026/0121238 A1
(43) Pub. Date: Apr. 30, 2026

(54) LID ELEMENT OF A BATTERY MODULE AND A BATTERY MODULE HAVING SUCH A LID ELEMENT

(71) Applicant: Robert Bosch GmbH, Stuttgart (DE)

(72) Inventor: Sinasi Temiz, Ebersbach (DE)

(21) Appl. No.: 19/375,410

(22) Filed: Oct. 31, 2025

(30) Foreign Application Priority Data
Oct. 31, 2024 (DE) 10 2024 210 531.7

(51) Int. Cl. H01M 50/503; H01M 10/48; H01M 50/209; H01M 50/271; H01M 50/519

(52) U.S. Cl. CPC H01M 50/503; H01M 10/482; H01M 10/486; H01M 50/209; H01M 50/271; H01M 50/519

(57) ABSTRACT

A lid element of a battery module has a carrier element, which receives a plurality of cell connectors in a form-fit manner. The lid element further includes a flexible printed circuit board and at least one temperature sensor. The lid element includes at least one receptacle, within which the at least one temperature sensor is arranged, and the at least one receptacle is arranged between the flexible printed circuit board and a lateral protrusion of one of the cell connectors.

### BACKGROUND

The invention relates to a lid element according to the type defined in the disclosure. The object of the present invention is also a battery module comprising such a lid element.

A battery module comprises a plurality of individual battery cells, each of which has a positive voltage tap and a negative voltage tap, wherein the respective voltage taps are electrically conductively connected to one another for an electrically conductive serial and/or parallel connection of the plurality of battery cells to one another and may thus be interconnected to form the battery module. In particular, the battery cells may each have a first voltage tap, in particular, a positive voltage tap, and a second voltage tap, in particular, a negative voltage tap, which are electrically conductively connected to each other by means of cell connectors, such that an electrically serial and/or parallel interconnection is formed.

Battery modules, in turn, are further connected together to form batteries or entire battery systems.

### SUMMARY

A lid element with the features of the disclosure offers the advantage that a reliable measurement of a temperature of a battery cell of a battery module can be provided.

According to the invention, a lid element of a battery module is provided for this purpose. Such lid element comprises a carrier member which receives a plurality of cell connectors in a form-fit manner. The lid element further comprises a flexible printed circuit board comprising at least one temperature sensor. Furthermore, the lid element comprises at least one receptacle within which the at least one temperature sensor is arranged. The at least one receptacle is arranged between the flexible printed circuit board and a lateral protrusion of one of the cell connectors.

At this point, it is noted that the at least one receptacle is arranged in mechanical contact with both the flexible printed circuit board and the lateral protrusion of the cell connector. Furthermore, it is preferred that the receptacle is e.g. configured as a rectangular frame element, which comprises four frame legs that limit an opening within which the temperature sensor is arranged.

It should also be noted at this point that a flexible printed circuit board made of metal, such as copper, comprises conductor tracks and contact elements, which are at least partially received between the two flexibly configured carrier elements, such as carrier films made of plastic. In particular, the contact elements and at least partially also the conductive tracks can be uncovered by the carrier elements and thus be exposed so that electrical contacting is possible.

It should further be noted at this point that the temperature sensor is preferably configured as an NTC sensor. By this, a reliable measurement of temperature may be provided. It is expedient if the lateral protrusion of the cell connector is further connected to the flexible printed circuit board in a manner that is electrically conductive in nature, such that a measurement of a voltage on the cell connector can be formed. In particular, a voltage of a battery cell, to which the cell connector is preferably electrically conductively connected in a material-locking manner, can thereby be tapped. Preferably, a cell connector made of aluminum is connected to a conductor track of the flexible circuit board or a contact element of the flexible circuit board formed from copper by means of material-locking resistive welding.

It is also advantageous if a thermal compensating element is arranged opposite the flexible printed circuit board. In other words, this means that the receptacle is arranged on a top side of the flexible printed circuit board and the thermal compensating element is arranged on a bottom side of the flexible printed circuit board. This provides the particular advantage that the temperature sensor can be reliably connected to a housing of a battery cell in a thermally conductive manner. Particularly preferably, the thermal compensating element may be provided in the form of an adhesive tape.

It is of particular advantage in this case if the thermal compensating element comprises a thermal compensating material. Such a thermal compensating material is arranged between an adhesive layer arranged on the flexible printed circuit board and an electrically insulating insulation layer. This also offers the particular advantage that the insulation layer can electrically insulate the flexible circuit board from a battery cell, that the thermal compensating material can form a particularly reliable thermally conductive connection of the temperature sensor to the housing of the battery cell, and that the adhesive layer can form a reliable connection of the thermal compensating element to the flexible circuit board.

In particular, the adhesive layer may comprise, for example, an acrylate adhesive.

It is particularly expedient when the lateral protrusion of the cell connector comprises an elastically formed spring portion. The lateral protrusion of the cell connector can thus particularly reliably apply a force on the receptacle in such a way that the flexible printed circuit board or the thermal compensating material is arranged on the housing of the battery cell.

According to a preferred aspect of the invention, a resistor is further arranged adjacent the temperature sensor within the receptacles, which is configured to compensate for a cell voltage. In this case, the heat can also preferably be transferred to other battery cells by means of the thermal compensating element.

Particularly preferably, the carrier element as well as the receptacles are made of a plastic and the cell connectors are made of aluminum.

Another object of the present invention is a battery module comprising a plurality of battery cells, which are designed in particular as prismatic battery cells and a lid element previously described. In this case, the plurality of battery cells can be connected in parallel and/or in series in an electrically conductive manner by means of cell connectors. Further, the temperature sensor is connected to a housing of one of the battery cells in a thermally conductive manner.

It is expedient if a cell connector formed in a material-locking manner, in a particularly welded, and is connected to a voltage tap of a first battery cell and a voltage tap of a second battery cell in an electrically conductive manner.

At this point, it is noted that a counterforce is formed by means of a preferably material-locking connection between the cell connector and a voltage tap of a battery cell, so that the lateral protrusion of the cell connector, in particular due to the elastically configured spring portion, presses the flexible printed circuit board or the thermal compensating material resiliently against the housing of the battery cell or arranges it in reliable contact with such a housing.

Accordingly, it is expedient when the lateral protrusion of the cell connector presses against the receptacle under elastic deformation of an elastically formed spring portion of the lateral protrusion in the manner that a thermal compensating element arranged on the flexible printed circuit board is pressed against a housing of a battery cell.

At this point, it should be noted that prismatically formed battery cells each comprise a battery cell housing with a total of six lateral surfaces, which are arranged in pairs opposing each other and essentially parallel to each other. In addition, lateral surfaces arranged adjacent one another are arranged perpendicular to one another. The electrochemical components of the respective battery cell are accommodated within the interior of the battery cell housing. Typically, two voltage taps, in particular a positive voltage tap and a negative voltage tap, are arranged on an upper lateral surface, which is referred to as the cover surface. The lower lateral surface opposite the upper lateral surface is referred to as the bottom surface.

### BRIEF DESCRIPTION OF THE DRAWINGS

Exemplary embodiments of the invention are shown in the drawings and explained in more detail in the following description.

### Shown are:

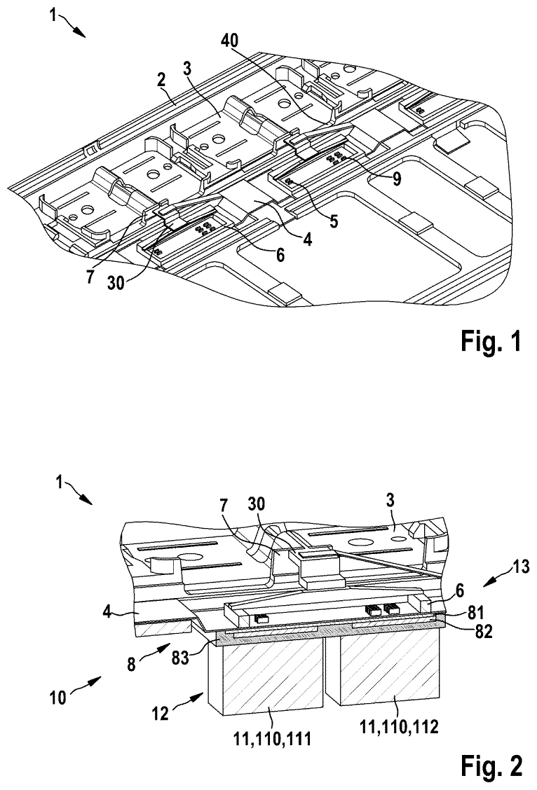

FIG. 1 a perspective view of an embodiment of a lid element of a battery module according to the invention,

FIG. 2 an embodiment of a battery module according to the invention in a sectional view.

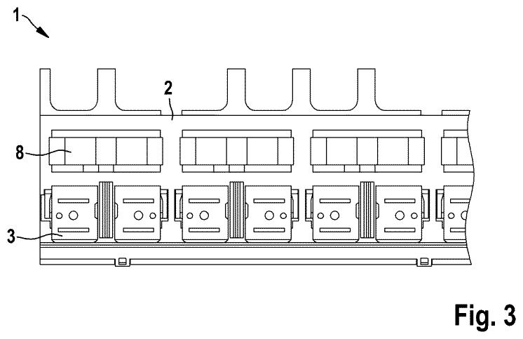

FIG. 3 a bottom view of an embodiment of a lid element of a battery module according to the invention,

### DETAILED DESCRIPTION

FIG. 1 shows a perspective view of an embodiment of a lid element 1 of a battery module 10 according to the invention,

The lid element 1 comprises a carrier element 2. The carrier element 2 is preferably formed from a plastic.

Such a carrier element 2 receives a plurality of cell connectors 3 in a form-fit manner. In particular, the cell connectors 3 may be connected to the carrier element 2 by means of clips. The cell connectors 3 are preferably made of aluminum.

Further, the lid element 1 comprises a flexible printed circuit board 4. Such a flexible printed circuit board 4 comprises at least one temperature sensor 5.

Furthermore, the cell connectors 3 each comprise or at least one cell connector 3 comprises a lateral protrusion 7. In this case, the lateral protrusion 7 of a cell connector 3 is preferably further connected to the flexible printed circuit board 4 in a manner that is electrically conductive in nature, such that a measurement of a voltage on the cell connector 3 can be formed. For this purpose, a contact arm 40 of the flexible printed circuit board 4 can be connected to the lateral protrusion 7 of the cell connector 3 in a material-locking manner.

Further, the lateral protrusion 7 of the cell connector 3 comprises a spring section 30, which is elastically formed.

Further, the lid element 1 comprises at least one receptacle 6. The receptacles 6 are preferably configured as frame elements in each case. Within such a receptacle 6, the at least one temperature sensor 5 is arranged. The receptacles 6 are preferably made of a plastic.

The receptacle 6 is arranged between the flexible printed circuit board 4 and a lateral protrusion 7 of a cell connector 3.

According to the embodiment according to FIG. 1, a resistor 9 is further arranged within the receptacle 6 adjacent to the temperature sensor 5, which is configured to compensate for a cell voltage.

FIG. 2 shows an embodiment of a battery module 10 according to the invention in a sectional view.

The battery module 10 comprises a plurality of battery cells 11.

The battery cells 11 are designed in particular as prismatic battery cells 110.

The battery module 10 further comprises a lid element 1 according to the invention.

The cell connectors 3 are connected to a voltage tap 13 of a battery cell 11 in a material-locking manner, in particular by means of resistance welding. In particular, a cell connector 3 is connected to a voltage tap 13 of a first battery cell 111 and a voltage tap 13 of a second battery cell 112 in an electrically conductive manner, so that an electrically conductive serial and/or parallel connection is formed.

From FIG. 2, it can be seen that a thermal compensating element 8 is arranged on the flexible printed circuit board 4 opposite the receptacle 6.

Such a thermal compensating element 8 comprises an adhesive layer 81, which is arranged on the flexible printed circuit board 4, and which thereby forms a reliable attachment of the thermal compensating element 8 to the flexible printed circuit board 4. Furthermore, the thermal compensating element 8 comprises a thermal compensating material 82, which forms a reliable thermal bond between the flexible printed circuit board 4 and a battery cell 11. In addition, the thermal compensating element 8 comprises an insulation layer 83, which is electrically insulating and thereby forms a reliable electrical insulation between the battery cell 11 and the flexible printed circuit board 11.

The temperature sensor 5, which is received by the flexible printed circuit board 4, is connected to a housing 12 of a battery cell 11 in a thermally conductive manner. In particular, the lateral protrusion 7 presses the flexible printed circuit board 4 with the thermal compensating element 8 arranged thereon against the housing 12 of the battery cell 11 by means of the spring portion 30 via the receptacle 6.

FIG. 3 shows a bottom view of an embodiment of a lid element 1 of a battery module 10 according to the invention,

In particular, the arrangement of the thermal compensating element 8 can be seen on the flexible printed circuit board 4. Furthermore, the cell connectors 3 can also be seen.

1. A lid element of a battery module (10) with a carrier element (2), which receives a plurality of cell connectors (3) in a form-fit manner, wherein the lid element (1) further comprises a flexible printed circuit board (4), comprising at least one temperature sensor (5), wherein the lid element (1) comprises at least one receptacle (6), within which the at least one temperature sensor (5) is arranged, and the at least one receptacle (6) is arranged between the flexible printed circuit board (4), and a lateral protrusion (7) of one of the cell connectors (3).

2. The lid element according to claim 1, wherein the lateral protrusion (7) of the cell connector (3) is further connected in a material-locking manner and in an electrically conductive manner to the flexible printed circuit board (4), and wherein a measurement of a voltage at the cell connector (3) can be formed.

3. The lid element according to claim 1, wherein a thermal compensating element (8) is arranged opposite the receptacle (6) on the flexible printed circuit board (4).

4. The lid element according to claim 3, wherein the thermal compensating element (8) comprises a thermal compensating material (82), which is arranged between an adhesive layer (81) arranged on the flexible printed circuit board (4), and an electrically insulating insulation layer (83).

5. The lid element according to claim 1, wherein the lateral protrusion (7) of the cell connector (3) comprises a resiliently formed spring portion (30).

6. The lid element according to claim 1, wherein adjacent the temperature sensor (5) within the receptacle (6), a resistor (9) is also arranged to compensate for cell voltage.

7. The lid element according to claim 1, wherein the carrier element (2) and the receptacle (6) are made of a plastic, and the cell connectors (3) are made of aluminum.

8. A battery module with a plurality of battery cells (11), and a lid element (1) according to claim 1, wherein the plurality of battery cells (11) are connected in parallel and/or in series in an electrically conductive manner by means of the cell connectors (3), wherein the temperature sensor (5) is also connected to a housing (12) of a battery cell (11) in a thermally conductive manner.

9. The battery module according to claim 8, wherein a cell connector (3) is connected in an electrically conductive manner to a voltage tap (13) of a first battery cell (111), and to a voltage tap (13) of a second battery cell (112).

10. The battery module according to claim 8, wherein the lateral protrusion (7) of the cell connector (3) presses against the receptacle (6) in a manner similar to an elastic deformation of the lateral protrusion (7), such that a thermal compensating element (8) arranged on the flexible printed circuit board (4) is pressed against.

11. The battery module according to claim 8, wherein the plurality of battery cells (11) are each configured as prismatic battery cells (110).
